(19) United States
(12) Patent Application Publication
(10) Pub. No.: US 2009/0079324 A1
(43) Pub. Date: Mar. 26, 2009

(54) FLUORESCENT LAMP

(76) Inventors: Istvan Deme, Budapest (HU); Geza Szeghy, Dunakeszi (HU); Gabriella Revesz, Dunakeszi (HU)

Correspondence Address: General Electric Company;GE Global Patent Operation, PO Box 861, 2 Corporate Drive, Suite 648, Shelton, CT, 06484, US

(21) Appl. No.: 11/858,512

(22) Filed: Sep. 20, 2007

(51) Int. Cl. H01J 1/62; H01J 17/20; H01J 9/02

(52) U.S. Cl. 313/489; 313/643; 445/26

(57) ABSTRACT

A fluorescent lamp includes a light-transmissive envelope, means for providing a discharge, a gas fill comprising mercury vapor and an inert gas sealed inside the envelope, a barrier layer on the inner surface of the envelope and a phosphor layer on the barrier layer. The phosphor layer contains at least one phosphor and alpha alumina and has a coating weight from about 1 to about 5 mg/cm².

### FIELD OF THE INVENTION

This invention relates to fluorescent lamps and more particularly, to fluorescent lamps having reduced mercury consumption.

### BACKGROUND OF THE INVENTION

Fluorescent lamps include a lamp envelope containing a filling of mercury and a rare gas to maintain a gas discharge during operation. The lamp contains a quantity of mercury sufficient to maintain the desired mercury vapor pressure within the sealed lamp envelope. The lamp utilizes an electric discharge to excite mercury vapor and produce ultraviolet light. The inner surface of the lamp envelope has a luminescent coating, often a blend of phosphors, which fluoresces and emits visible light upon excitation by the ultraviolet radiation. So long as the mercury vapor within the lamp remains at the desired pressure, the lamp will continue to operate normally and produce maximum lumens.

Unfortunately, the mercury available for the vapor phase is depleted over time from operation of the lamp. The mercury is consumed by reactions with the phosphors in the luminescent coating or phosphor layer and is also consumed by other lamp components, such as the glass envelope, and can react with contaminants retained in the lamp, especially, by components having a high surface area. As the quantity of mercury becomes too low to saturate the vapor phase, the lumen output of the lamp decreases. The lumen output also decreases during burning of the lamp, because reaction products of mercury that are formed during the lamp operation can absorb UV and visible light.

Lumen output may be measured by the initial lumen output and by lumen output maintenance, which is the lumen output of the lamp over time. Some conventional ways to increase lumen output are to provide a barrier coating between the glass envelope and the luminescent coating or phosphor layer, select certain types of phosphors of high efficiency, increase the thickness of the phosphor layer and adjust the fill pressure and gas composition within the glass envelope. These adjustments can improve the lumen output in one aspect, but can decrease the lumen output in other aspects or create other problems, such as increased warm-up times.

Barrier layers insulate the glass envelope from the mercury vapor and reflect UV light that passes through the luminescent coating or phosphor layer, but the barrier layer can increase warm-up times. Barrier layers are typically prepared from materials having small particle sizes and high specific surface area, which have high adsorptivity. As a result, barrier layers can retain high levels of contaminants, such as water, carbon dioxide and carbon monoxide. These contaminants can react with the mercury ions in the lamp and cause long warm-up times, especially when the barrier layer is thick.

Rare earth phosphors applied at relatively high coating weights and more than one phosphor layer can also reduce mercury consumption, but this procedure can be expensive and may create problems with coating thickness. Increased coating thicknesses improve the lumen output, but can increase warm-up times. Decreased coating thicknesses result in good warm-up times, but reduce the initial lumen output.

Increasing the mercury fill in the glass envelope reduces the risk of a shortened lifetime from mercury vapor depletion, but creates environmental concerns.

International Publication No. 2007/034414 A2 discloses a phosphor layer applied directly to the inner surface of the glass envelope. The phosphor layer contains a fine particle size alpha alumina. The lumen output maintenance is improved, but the initial lumen output is decreased.

What is needed is a fluorescent lamp having improved lumen output with improved warm-up times.

### SUMMARY OF THE INVENTION

In one embodiment, a fluorescent lamp comprising a light-transmissive envelope, means for providing a discharge, a gas fill comprising mercury vapor and an inert gas sealed inside said envelope, a barrier layer on the inner surface of the envelope and a phosphor layer on the barrier layer, said phosphor layer comprising at least one phosphor and alpha alumina, wherein said phosphor layer has a coating weight from about 1 to about 5 mg/cm².

In another embodiment, a method for preparing an envelope for a fluorescent lamp comprises coating a light-transmissive envelope with a barrier layer on an inner surface of the envelope and coating a phosphor layer on the barrier layer, said phosphor layer comprising at least one phosphor and alpha alumina and wherein said phosphor layer has a coating weight from about 1 to about 5 mg/cm².

The various embodiments provide fluorescent lamps having decreased mercury consumption, improved initial lumen output and lumen maintenance and having good warm-up times.

### BRIEF DESCRIPTION OF DRAWINGS

FIG. 1 is a diagram and partially in section, depicting an exemplary embodiment of a fluorescent lamp.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a fluorescent lamp comprises a light-transmissive envelope, means for providing a discharge, a gas fill comprising mercury vapor and an inert gas sealed inside said envelope, a barrier layer on the inner surface of the envelope and a phosphor layer on the barrier layer, said phosphor layer comprising at least one phosphor and alpha alumina, wherein said phosphor layer has a coating weight from about 1 to about 5 mg/cm².

A fluorescent lamp is a mercury vapor discharge fluorescent lamp. The lamp may include electrodes or may be electrodeless. The lamp may be linear, but any size shape or cross section may be used. In one embodiment, the lamp is about 2 to about 8 feet long. In another embodiment, the lamp is a T5 lamp, which is a fluorescent lamp having an outer diameter of about ⅝ inch. In one embodiment, the lamp is a T5 lamp having a length of about 48 inches.

The fluorescent lamp has a lamp envelope with a gas fill of mercury and an inert gas to maintain a gas discharge during operation. The radiation emitted by the gas discharge is mostly in the ultraviolet (UV) region of the electromagnetic spectrum, with only a small portion in the visible region of the spectrum. The inner surface of the lamp envelope has a phosphor layer containing phosphors and inorganic oxide. The phosphors are luminescent materials that emit visible light upon excitation by the ultraviolet radiation.

The lamp contains a means for providing a discharge. In one embodiment, the means for providing a discharge is a radio transmitter adapted to excite mercury vapor atoms via transmission of high frequency electromagnetic energy, radiation or signal.

In another embodiment, the means for providing a discharge is a pair of electrodes or electrode structures for providing an arc discharge. The bases of the electrodes are embedded in a glass stem, which is sealed at each end of the envelope. The electrodes have a tungsten coil, which is coated with an emitter, such as the oxides of barium, strontium, and calcium. A base pin is connected to each of the outer ends of the electrodes and a voltage is applied from a stabilizer to the electrodes via the base pins, which are held in place by plates in the bases.

When a high voltage is applied to the electrodes by the stabilizer, the tungsten coils heat up, causing electrons to be emitted from the emitter coating on the tungsten coils. The electrons collide with the mercury vapor enclosed in the envelope, generating ultraviolet light.

The fluorescent lamp contains a light-transmissive envelope, which contains a gas fill and is hermetically sealed. The envelope may be any type of shape. In one embodiment, the envelope is linear. In another embodiment, the envelope may have one or more bends, for example, a U-bend or circular bend. In one embodiment, the envelope has a circular cross-section and in another embodiment, the envelope is an elongated tube.

The envelope is light-transmissive, which means that it is prepared from a material that will allow light, particularly visible light, to pass through the envelope. In one embodiment, the envelope comprises glass. In another embodiment, the glass envelope is made from lime glass or soda-lime glass.

The gas fill comprises mercury vapor and an inert gas. The inert gas may be a noble gas, such as argon, krypton, neon, xenon or a mixture thereof.

In one embodiment, the fill gas has a total pressure of about 1 to about 5 torr at 25° C. In another embodiment, the fill gas has a total pressure of about 2 to about 4.5 torr at 25° C. and in another embodiment, the fill gas has a total pressure of about 2.5 to about 4 torr at 25° C.

The barrier layer is disposed on the inner surface of the envelope. The barrier layer protects the envelope from reaction with the mercury vapor and reflects UV light back into the phosphor layer where it may be utilized, leading to improved phosphor utilization and a more efficient production of visible light. The barrier layer may contain any type of material suitable for reflecting UV light that is non-mercury absorptive and capable of forming a dense, compact layer on the surface of the envelope. In one embodiment, the barrier layer comprises an inorganic oxide. In another embodiment, the barrier layer comprises alumina, silica or yttria particles. In one embodiment, the barrier layer comprises alumina and may be an alpha alumina or a gamma alumina. Blends of alumina may be used, such as a blend of alpha alumina and gamma alumina. In one embodiment, the alumina particle blend comprises from about 5 to about 80 percent by weight, based on the weight of the blend of gamma alumina. In another embodiment, the alumina blend is from about 10 to about 65 percent by weight, based on the weight of the blend of gamma alumina. In another embodiment, the blend is from about 20 to about 40 percent by weight, based on the weight of the blend of gamma alumina. In one embodiment, the blend comprises from about 20 to about 95 percent by weight, based on the weight of the blend of alpha alumina. In another embodiment, the blend comprises from about 35 to about 90 percent by weight, based on the weight of the blend of alpha alumina. In another embodiment, the blend comprises from about 60 to about 80 percent by weight based on the weight of the blend of alpha alumina.

Primary particle sizes for the inorganic oxides range from about 10 to about 100 nm in diameter. The inorganic oxide particles may agglomerate and the agglomerated particle sizes may be from about 20 nm to about 2000 nm. The inorganic oxides can have a specific surface area from about 2 to about 200 m²/g.

The phosphor layer contains phosphors, which are luminescent materials and alpha alumina. The phosphors may be any type of phosphor that absorbs ultraviolet light. In one embodiment, the phosphors are rare earth phosphors or halophosphate phosphors. In one embodiment, the phosphor layer is a rare earth triphosphor layer. In another embodiment, the phosphor contains a blend of halophosphate phosphors and rare earth phosphors.

The rare earth phosphors may be a rare earth triphosphor blend including red-emitting phosphors, such as yttrium oxide activated with europium (YEO or YOX) and strontium red (SR), green-emitting phosphors, such as lanthanum phosphate activated with cerium and terbium, aluminum oxide activated with cerium and terbium and cerium borate activated with terbium and blue-emitting phosphors, such as strontium, calcium, barium chloroapatite activated with europium (SECA) and alkaline earth metal (such as barium) aluminate activated with europium (BAM). In one embodiment, the rare earth phosphors are from about 33 to about 70 percent by weight, including about 42 to about 56 percent by weight and including 50 percent by weight of red-emitting phosphors. In another embodiment, the rare earth phosphor comprises from about 25 to about 45 percent by weight, including from about 30 to about 38 percent by weight and including 35 percent by weight of green-emitting phosphors. In another embodiment, the rare earth phosphors comprise from about 5 to about 30 percent by weight, including from about 10 to about 23 percent by weight and including about 15 percent by weight blue-emitting phosphors.

The rare earth phosphor particles have a diameter from about 1 to about 12 micrometers, including from about 2 to about 6 micrometers and including from about 3 to about 5 micrometers.

The halophosphors may be any type of halophosphate phosphors known in the art. In one embodiment, the halophosphor particles are calcium halophosphate activated with antimony and manganese. In another embodiment, the halophosphor is calcium fluorophosphate or calcium chlorophosphate activated with manganese and antimony. In one embodiment, the manganese is from about 0.1 to about 5 mole percent of the halophospor. In another embodiment, the amount of manganese is from about 1 to about 4 mole percent of the halophosphor and including from about 2 to about 3 mole percent of the halophosphor. In one embodiment, the antimony is from about 0.2 to about 5 mole percent of the halophosphor. In another embodiment, the antimony is from about 1 to about 4 mole percent of the halophosphor and including from about 1 to about 2 mole percent of the halophosphor.

In one embodiment, the halophosphor particles are from about 7 to about 13 micrometers in diameter. In another embodiment, the particles are from about 8 to about 12 micrometers in diameter and including from about 9 to about 11 micrometers in diameter. In one embodiment, the halophosphor particles contain less than about 5 percent by weight fines, that is, particles having a diameter of 5 micrometers or less. In another embodiment, the halophosphor particles contain less than about 1 percent by weight fines.

In one embodiment, the phosphor layer comprises a blend of halophosphors and rare earth phosphors. In one embodiment, the phosphor layer comprises from about 60 to about 80 percent by weight rare earth phosphors and from about 20 to about 40 percent by weight halophosphors, based on the weight of the phosphor blend. In another embodiment, the phosphor layer comprises from about 65 to about 75 percent by weight rare earth phosphors and from about 25 to about 35 percent by weight halophosphors, based on the weight of the phosphor blend.

The phosphor layer also comprises alpha alumina. In one embodiment, the alpha alumina has a surface area of no greater than about 10 m²/g. In another embodiment, the alpha alumina has a surface area from about 0.5-10 m²/g, including from about 3 to about 8 m²/g. In another embodiment, the alpha alumina has a surface area from about 4 to about 6 m²/g. In one embodiment, the alpha alumina has an agglomerated median (D50) particle size (diameter) below about 600 nm. In another embodiment, the alpha alumina has a D50 particle size from about 100 to about 550 nm. In another embodiment, the alpha alumina has a D50 particle size from about 100 to about 500 nm, including a D50 particle size from about 200 to about 400 nm.

In one embodiment, the alumina has a high purity, such as 99.99% pure, having a minimum of light-absorbing impurities. In one embodiment, the alumina has <20 ppm sodium, <50 ppm potassium, <10 ppm iron and <50 ppm silicone.

In one embodiment, the phosphor layer comprises from about 2 to about 10 percent by weight alpha alumina, based on the weight of the phosphors and alumina. In another embodiment, the phosphor layer comprises from about 2 to about 8 percent by weight alpha alumina, including from about 3 to about 6 percent by weight alpha alumina, wherein the weight is based on the weight of the phosphors and alumina. In one embodiment, the phosphor layer comprises from about 90 to about 98 percent by weight phosphors, based on the weight of the phosphors and alumina. In another embodiment, the phosphor layer comprises from about 92 to about 98 percent by weight phosphors, including from about 94 to about 97 percent by weight phosphors, based on the weight of the alumina and phosphors.

The barrier layer and phosphor layer are formed on the internal surface of the discharge envelope by conventional coating techniques. In one embodiment, the barrier layer is prepared by dispersing inorganic oxide in water, such as deionized or demineralized water, with a dispersing agent, such as ammonium polyacrylate or acetic acid and optionally, other additives. In one embodiment, the resulting suspension is from about 2 to about 15 percent by weight inorganic oxide and from about 0.1 to about 3 percent by weight dispersing agent and any other additives used, wherein the weights are based on the weight of the suspension. The suspension is then applied as a coating by conventional upflush or downflush coating techniques to the inside of the envelope and the layer is dried. In one embodiment, the liquid suspension is applied by flushing the liquid suspension down the lamp envelope to flow over the inner surface of the envelope until it exits from the other end. The solution is dried in a drying chamber. The layer is dried in any conventional manner. In one embodiment, the layer is heated until dry. The layer may be heated in any conventional manner. In one embodiment, the layer is heated with a hot air blow type heater until dry. In another embodiment, the layer is heated from about 40° C. to about 100° C. In another embodiment, the layer is heated from about 4 to about 20 minutes.

After the barrier layer is sufficiently dried, the phosphor layer may be applied over the barrier layer. It is applied in a similar process to the application of the barrier layer. In one embodiment, the phosphor layer is prepared by dispersing alpha alumina powder and phosphor particles in water, such as deionized or demineralized water, with a dispersing agent, such as ammonium polyacrylate and a nonionic surfactant, such as nonylphenyl-ethoxylate. A thickener is then added, such as polyethylene oxide and optionally, other additives. In one embodiment, the resulting suspension is from about 5 to about 30 percent by weight phosphor, from about 0.05 to about 0.5 percent by weight, based on the weight of the phosphors, of a dispersing agent, from about 0.1 to about 0.5 percent by weight, based on the weight of the phosphors, of a surfactant and from about 2 to about 10 percent by weight, based on the weight of the phosphors, of a thickener and any other additives used. The suspension is then applied as a coating by conventional coating techniques over the barrier layer and the layer is dried. In one embodiment, the liquid suspension is applied by flushing the liquid suspension down the lamp envelope to flow over the dried barrier layer until it exits from the other end. The solution is dried in a drying chamber. The layer is dried in any conventional manner. In one embodiment, the layer is heated until dry. The layer may be heated in any conventional manner. In one embodiment, the layer is heated with a hot air blow type heater until dry. In one embodiment, the layer is heated from about 40° C. to about 100° C. In another embodiment, the layer is heated from about 4 to about 30 minutes.

After the barrier layer and the phosphor layer have been coated and dried, the coated envelope is baked by conventional means using the highest temperature the envelope material allows. In one embodiment, the envelope is heated to at least 500° C. In another embodiment, the envelope is heated to at least 600° C. and in another embodiment, the envelope is heated to at least 630° C. In one embodiment, the envelope is heated and kept at a peak temperature for at least about 30 seconds. In another embodiment, the envelope is heated from about 0.5 to about 10 min.

In the heating stage, the components other than alumina and phosphor are driven off, leaving only alumina and phosphor behind.

In one embodiment, the barrier layer is applied so that the weight of the inorganic oxide in the barrier layer (the coating weight) is from about 0.01 to about 3 mg of inorganic oxide per cm². In another embodiment, the coating weight is from about 0.04 to about 1 mg of inorganic oxide per cm² and in another embodiment, the coating weight is from about 0.04 to about 0.7 mg of inorganic oxide per cm². The desired coating weight can be obtained by conventional means, such as by adjusting the concentration of the oxide, the viscosity of the coating suspension and the drying conditions, such as the temperature, humidity and velocity of the drying airflow if a hot air blow type heater is used.

In one embodiment, the phosphor layer is applied so that the weight of the layer (the “coating weight”) is from about 1 to about 5 mg/cm². In another embodiment, the coating weight of the phosphor layer is from about 1.5 to about 4 mg/cm², including from about 2 to about 3 mg/cm². The desired coating weight can be obtained by conventional means, such as by adjusting the concentration of the phosphors and alumina, the viscosity of the coating suspension and the drying conditions, such as the temperature, humidity and velocity of the drying airflow if a hot air blow type heater is used.

Additives may optionally be used to make the coating suspension for the barrier layer. The additives may include surfactants and thickeners. The surfactants may be any type of conventional surfactant. Examples of surfactants include, but are not limited to, the block copolymer mixture of polyoxyethylene and polyoxypropylene, which are available under the trade name of Pluronic® from BASF and nonylphenol ethoxylate, which is available as Igepal® CO-530 from Rhodia.

The thickeners may include any type of conventional thickener. In one embodiment, the thickeners include is a nonionic, water soluble polymeric thickener, such as polyethylene oxide.

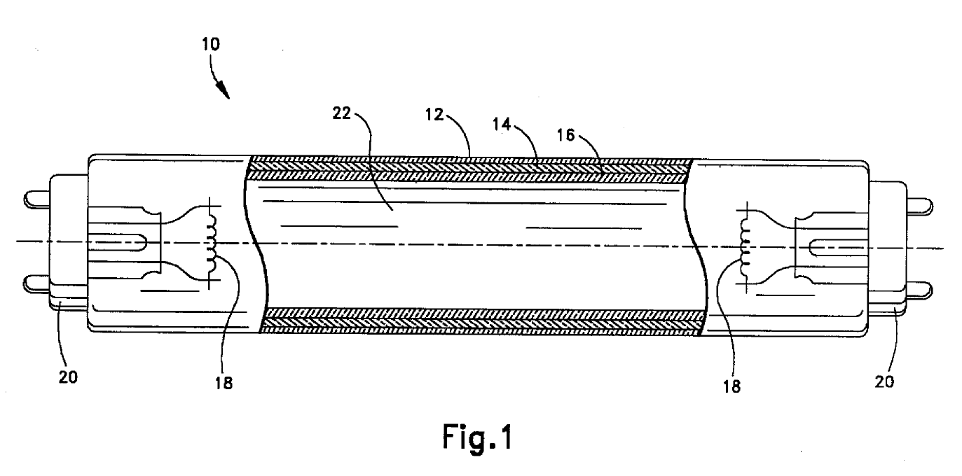

FIG. 1 shows a low pressure mercury vapor discharge fluorescent lamp 10. The fluorescent lamp 10 has a light-transmissive envelope 12. A barrier layer 14 is disposed on the inner surface of the envelope 12. A phosphor layer 16 is disposed on the inner surface of the barrier layer 14, so that the barrier layer 14 is between the envelope 12 and the phosphor layer 16.

The fluorescent lamp 10 is hermetically sealed by bases 20, which are attached at both ends of the envelope 12. A pair of spaced electrodes or electrode structures 18 are respectively, mounted on the bases 20. A discharge-sustaining fill gas 22 of mercury vapor and an inert gas is sealed inside the envelope 12.

In another embodiment, a method for preparing an envelope for a fluorescent lamp comprises coating a light-transmissive envelope with a barrier layer on an inner surface of the envelope and coating a phosphor layer on the barrier layer, said phosphor layer comprising at least one phosphor and alpha alumina and wherein said phosphor layer has a coating weight from about 1 to about 5 mg/cm².

In order that those skilled in the art will be better able to practice the present disclosure, the following examples are given by way of illustration and not by way of limitation.

### EXAMPLES

### Example 1

A 54W (4 foot) T5 lamp was made on a conventional horizontal finishing machine with a 4.5 mbar gas fill of 90% by volume Ar and 10% by volume Kr and about 2 mg/lamp liquid mercury dose. In a suitable bead mill, a concentrated acetic acid stabilized suspension of Aeroxide® C alumina (sold by Degussa) was made and then diluted with demineralized water to 2 weight % alumina. 2 g/kg of nonylphenyl-ethoxylate (Igepal® CO530) was added based on the weight of the suspension. The average (median) diameter of the alumina agglomerates in the suspension was measured to be 210 nm by low angle laser light scattering (LALLS).

The pre-washed bulbs were coated on a conventional upflush coater and the layer was dried with downward warm airflow of 65° C. at 4 m/s for 4 minutes. The weight of the coating per unit area of the glass surface was measured to be 0.04 mg of aluminum oxide/cm².

A phosphor layer was prepared from commercially available Eu(III) activated yttrium oxide red, Ce—Tb activated lanthanum phosphate green and Eu(II) activated Ba—Mg aluminate phosphors, 5% by weight of the phosphors of a polyethylene oxide (PEO) binder, 0.3% by weight of the phosphors of a polymethacrylic acid dispersant and 0.4% by weight, based on the weight of the phosphors, of a surfactant, nonylphenyl-ethoxylate (Igepal® CO530). 4 % by weight, based on the weight of the phosphors, of alpha alumina was added in the form of a fine dispersion.

The alpha alumina dispersion was prepared by dissolving 10% by weight, based on the weight of the aluminas, of a PEO binder, 0.8% by weight, based on the weight of the aluminas, of an ammonium polymethacrylate dispersant and a sufficient amount of concentrated ammonium hydroxide to increase the pH to above 9, and by adding a blend of the following alumina materials: 90 weight % of Ceralox® SPA alpha AF (sold by Sasol) and 10 weight % Aeroxide® C (sold by Degussa). The mix was added to a bead mill and milled until the median diameter (D50) of the suspended particles was measured to be 400 nm by LALLS.

A suitable amount of this suspension was added to the phosphor coating suspension to prepare a phosphor coating suspension having 4% by weight total alumina based on the weight of the phosphors. (The PEO binder totaled 5.4% by weight, based on the weight of the phosphors.) The barrier coated bulbs were then coated with this phosphor suspension on a conventional upflush coating machine and the bulbs then were dried with downward hot airblow of 80° C. at 4 m/s velocity for 8 minutes. The weight of the phosphor coating was 3.7 mg/cm² after pyrolysing off the organic materials at +600° C.

The finished lamps were burned on standard commercial electronic gears and tested with standard reference photometry. At 100 hours, the efficacy was found to be 89.9 lumens/Watt (average of 6 lamps with a standard deviation of 0.2). The ramp-up time to reach 80% of the final lumens was 22 seconds (average of 6 lamps with a standard deviation of 1). At 1000 hours, the measured lumen/Watt depreciation relative to 100 hr was 4% and the amount of Hg loss to the different lamp parts was 0.16 mg measured with wet chemical analysis.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

Having described the invention, that which is claimed is:

1. A fluorescent lamp comprising a light-transmissive envelope, means for providing a discharge, a gas fill comprising mercury vapor and an inert gas sealed inside said envelope, a barrier layer on the inner surface of the envelope and a phosphor layer on the barrier layer, said phosphor layer comprising at least one phosphor and alpha alumina, wherein said phosphor layer has a coating weight from about 1 to about 5 mg/cm².

2. The lamp of claim 1 wherein the envelope comprises glass.

3. The lamp of claim 1 wherein the inert gas is selected from the group consisting of argon, krypton, neon, xenon and a mixture thereof.

4. The lamp of claim 1 wherein the barrier layer comprises an inorganic oxide.

5. The lamp of claim 4 wherein the inorganic oxide is selected from the group consisting of alumina, silica and yttria.

6. The lamp of claim 5 wherein the inorganic oxide is alumina and comprises gamma alumina.

7. The lamp of claim 4 wherein particle sizes for the inorganic oxides range from about 10 to about 100 nm in diameter.

8. The lamp of claim 4 wherein agglomerated particle sizes for the inorganic oxides range from about 20 nm to about 2000 nm.

9. The lamp of claim 4 wherein the inorganic oxides have a specific surface area from about 2 to about 200 m²/g.

10. The lamp of claim 1 wherein the barrier layer has a coating weight from about 0.01 to about 3 mg of inorganic oxide per cm².

11. The lamp of claim 1 wherein the phosphors are rare earth phosphors.

12. The lamp of claim 11 wherein the rare earth phosphors is a rare earth triphosphor blend.

13. The lamp of claim 11 wherein particles of the rare earth phosphors have a diameter from about 1 to about 12 micrometers.

14. The lamp of claim 1 wherein the alpha alumina has a surface area no greater than about 10 m²/g.

15. The lamp of claim 1 wherein the alpha alumina has an agglomerated median particle diameter below about 600 nm.

16. The lamp of claim 1 wherein the alpha alumina is present in the phosphor layer from about 2 to about 10 percent by weight, based on the weight of the phosphor and alumina.

17. The lamp of claim 16 wherein the phosphor layer comprises from about 90 to about 98 percent by weight phosphors, based on the weight of the phosphors and alumina.

18. The lamp of claim 1 wherein the fluorescent lamp is a T5 lamp having a length of about 48 inches.

19. A method for preparing an envelope for a fluorescent lamp comprising coating a light-transmissive envelope with a barrier layer on an inner surface of the envelope and coating a phosphor layer on the barrier layer, said phosphor layer comprising at least one phosphor and alpha alumina and wherein said phosphor layer has a coating weight from about 1 to about 5 mg/cm².

20. The method of claim 19 wherein the envelope comprises glass.

21. The method of claim 19 wherein the barrier layer comprises an inorganic oxide.

22. The method of claim 21 wherein the inorganic oxide is selected from the group consisting of alumina, silica and yttria.

23. The method of claim 22 wherein the inorganic oxide is alumina and comprises a gamma alumina.

24. The method of claim 21 wherein particle sizes for the inorganic oxides range from about 10 to about 100 nm in diameter.

25. The method of claim 19 wherein the phosphors are rare earth phosphors.
